(19) United States
(12) Patent Application Publication
(10) Pub. No.: US 2024/0414055 A1
(43) Pub. Date: Dec. 12, 2024

(54) COMPUTER-IMPLEMENTED METHOD FOR THE AT LEAST PARTIALLY AUTOMATED CONFIGURATION OF A FIELD BUS, FIELD BUS SYSTEM, COMPUTER PROGRAM, COMPUTER-READABLE STORAGE MEDIUM, TRAINING DATA SET AND METHOD FOR TRAINING A CONFIGURATION AI MODEL

(71) Applicant: WAGO Verwaltungsgesellschaft mbH, Minden (DE)

(72) Inventor: Patrik ARNOLD, St Georgen (DE)

(73) Assignee: WAGO Verwaltungsgesellschaft mbH, Minden (DE)

(21) Appl. No.: 18/808,022

(22) Filed: Aug. 18, 2024

Related U.S. Application Data
(63) Continuation of application No. PCT/EP2023/051301, filed on Jan. 19, 2023.

(30) Foreign Application Priority Data
Feb. 17, 2022 (DE) 10 2022 103 812.2

(51) Int. Cl. H04L 41/08; G05B 19/05; H04L 41/0853; H04L 41/16

(52) U.S. Cl. CPC H04L 41/0886; G05B 19/05; H04L 41/0853; H04L 41/16; G05B 2219/1134

(57) ABSTRACT

A computer-implemented method for configuring a fieldbus that connects at least two participants of an associated fieldbus system, an associated fieldbus system, a computer program, a computer-readable storage medium, a training data set and a method for training a configuration AI model. The method comprises the following steps: an information collection step comprising collecting one or more fieldbus system information that characterize the associated fieldbus system, a configuration parameter value determination step comprising determining one or more parameter values of one or more configuration parameters for configuring the fieldbus of the fieldbus system. The determination of the one or more parameter values is dependent on at least part of the collected fieldbus system information. A configuration step includes configuring the fieldbus with the one or more parameter values of the one or more configuration parameters determined in the configuration parameter value determination step.

This nonprovisional application is a continuation of International Application No. PCT/EP2023/051301, which was filed on Jan. 19, 2023, and which claims priority to German Patent Application No. 10 2022 103 812.2, which was filed in Germany on Feb. 17, 2022, and which are both herein incorporated by reference.

### BACKGROUND OF THE INVENTION

### Field of the Invention

The present invention relates to a computer-implemented method for an at least partially automated configuration of a fieldbus which is to connect, or connects, at least two participants of an associated fieldbus system, as well as a fieldbus system with a first participant and a second participant which are to be connected to one another, or are connected to one another, by a fieldbus. Furthermore, the present invention relates to a computer program and a computer-readable storage medium, each comprising instructions which, when executed by a computer, cause the computer to carry out a predetermined method. Furthermore, the present invention relates to a training data set for training a configuration AI model (AI=“Artificial Intelligence”) and a method for training a configuration AI model.

### Description of the Background Art

A fieldbus enables a connection for data and/or energy transmission between several components (participants) of a network, wherein, for example, a control device, e.g., a programmable logic controller (PLC), may be connected by a fieldbus to one or more other components, for example one or more sensors or actuators, for data and/or energy transmission. Fieldbus connections are usually wired, with the connection usually being established through a suitable fieldbus cable.

Fieldbus systems with at least two participants, for example with a control device and one or more sensors or actuators, which are connected to one another by a fieldbus, as well as corresponding fieldbuses for data and/or energy transmission are generally known from the prior art, whereby various fieldbuses, in particular various types of fieldbuses, are known, which differ, in particular, in their respective protocol standard, i.e., in the way in which information can be transmitted or exchanged via the fieldbus and in what form.

For example, the following fieldbuses are known from the state of the art, in particular fieldbus types: CANopen, CC-Link, ControlNet, DeviceNet, Interbus, Profibus, Ethernet/IP, Modbus TCP and Profinet.

Due to the different protocol standards, not all fieldbuses are equally suitable for all applications. It is therefore advisable to select the fieldbus to be used based on the specific requirements of the individual case with regard to the network or based on the properties that are to be achieved with the fieldbus or the fieldbus system.

The selection of a suitable fieldbus is usually conducted manually based on available information on the network, in particular the information on the fieldbus participants to be connected, as well as the desired data and/or energy transfer, by a human expert who makes a selection decision based on the available information.

Once the fieldbus is selected, the fieldbus is to be configured to establish a functioning connection between the participants, e.g., a functioning communication or a functioning data and/or energy transmission between the participants of the fieldbus system via the fieldbus, i.e., the fieldbus is to be configured within the framework of the available protocol standard by storing corresponding parameter values for the respective, relevant configuration parameters for configuring the fieldbus so that the desired data and/or energy transmission between the individual participants of the network can be achieved via the fieldbus.

The configuration of the fieldbus is usually also conducted manually, although configuration software may be available to assist in the configuration of fieldbuses, which may make it easier to enter the respective parameter values. As an example, the engineering software “e!COCKPIT” available from WAGO corporation may be mentioned in this regard.

The manual selection of a suitable fieldbus and the subsequent configuration of the fieldbus requires expert knowledge and is time-consuming and error-prone. In the worst case, an incorrect selection and/or configuration of the fieldbus can lead to damage to one or more participants when commissioning the fieldbus system.

In addition, it is known to link (map) BACnet objects and PLC signals at least partially automated with a configuration software, see “PLCAutomapping” available at https://infosys.beckhoff.com/index.php?content= . . . /content/1031/tcbacnet/html/bacnet_examples_plc_automapping.htm&id=7456993167691197807, last accessed on 24.01.2022. This can reduce the effort involved in linking BACnet objects and PLC signals.

### SUMMARY OF THE INVENTION

It is therefore an object of the present invention to improve a configuration of a fieldbus, in particular to reduce the susceptibility to errors and the risk of damage to the participants of a fieldbus system resulting from an incorrect configuration and, above all, to make the configuration of a fieldbus more efficient.

This object is achieved in an example of the invention by a computer-implemented method, by a fieldbus system, by a computer program, by a computer-readable storage medium, by a training data set and by a method for training a configuration AI model.

A computer-implemented method according to the invention for the at least partially automated configuration of a fieldbus, which is to connect, or connects, at least two participants of an associated fieldbus system, comprises an information collection step, a configuration parameter determination step and a configuration step.

The information collection step comprises collecting, in particular at least partially automated collecting, fieldbus system information that characterizes the associated fieldbus system.

The configuration parameter determination step comprises determining, in particular at least partially automated determining, one or more parameter values of one or more configuration parameters for configuring the fieldbus of the fieldbus system, wherein the determining of the one or more parameter values is based on at least part of the collected fieldbus system information.

And the configuration step comprises configuring, in particular at least partially automated configuring, the fieldbus with the one or more parameter values of the one or more configuration parameters determined in the configuration parameter value determination step.

For the purposes of the present application, a “fieldbus system” can be a system with at least two components (participants) which are, or can be, connected to one another using a fieldbus and which may be connected in such a way that data and/or energy can be transmitted via the fieldbus, in particular according to a protocol standard characteristic of the respective fieldbus type.

A participant in a fieldbus system may, in particular, be a control device, for example a programmable logic controller (PLC), or a sensor or an actuator or another component, in particular an electronic device, for example a controller, which is configured to be connected to another component via a fieldbus. A first participant of the fieldbus system may be a control device, and a further participant may be a sensor, an actuator or another component that may be connected to at least one other component via a fieldbus.

A method according to the invention for configuring a fieldbus may be particularly suitable for configuring a fieldbus which is selected from a group comprising at least the following fieldbus types: CANopen, CC-Link, ControlNet, DeviceNet, Interbus, Profibus, Ethernet/IP, Modbus-TCP and/or Profinet.

In the context of the present invention, “fieldbus system information” can be information that characterizes the fieldbus system. This may, for example, be information that characterizes one or more properties of a participant in the fieldbus system, such as its maximum data transmission speed and/or data reception speed, the number and/or type of participants in the fieldbus system, information on the topology of the fieldbus system or the network, information on the connections available at one or more participants in the fieldbus system, information on the possible and/or required power supply of one or more participants, information on the possible and/or required data transmission speed, and/or information on possible and/or required data packets that can be, or are to be, sent via the fieldbus (size and number, with/without time stamp, frequency with which the data packets are to be sent).

In the context of the present invention, a “configuration parameter” can be a parameter which may be set by assigning a corresponding parameter value, whereby the fieldbus can be, or is, configured by setting one or more configuration parameters.

The determination of one or more parameter values in the configuration parameter value determination step may be carried out based on the properties of the fieldbus to be configured, i.e., in particular after at least one fieldbus, in particular at least one fieldbus type to be used, has been selected, and/or based on one or more of the participants to be connected by means of the fieldbus and/or based on what is to be transmitted via the fieldbus, such as data and/or energy. This makes it possible to achieve a fieldbus configuration that is particularly well adapted to the fieldbus system, in particular one that is particularly tailored to the selected fieldbus and the to be connected participants of the fieldbus system.

The collecting of fieldbus system information, the determining of one or more parameter values and/or the configuring of the fieldbus can each be carried out at least partially automated. Preferably, at least one of these steps is carried out fully automated. It is also conceivable that individual steps of a method according to the invention are carried out only partially automated, while other steps of a method according to the invention are carried out fully automated. For example, the collecting of fieldbus system information may be fully automated, while the configuring of the fieldbus, for example, may only be at least partially automated. It has proven to be particularly advantageous if the collecting of fieldbus system information and the determining of the configuration parameter values for configuring a selected fieldbus are carried out completely automated, as this significantly reduces the susceptibility to errors and can save a lot of time when configuring the fieldbus.

With a method according to the invention, the risk of errors and resulting damage to the participants of a fieldbus system, in particular due to incorrectly set configuration parameter values, may be significantly reduced in a particularly simple manner. Furthermore, a method according to the invention enables a particularly simple and reliable configuration of a field bus even without extensive expert knowledge. Furthermore, a method according to the invention may be used to ensure that similar fieldbuses are configured similarly or that identical fieldbuses are configured identically without much effort. This allow for a high level of reproducibility to be achieved when configuring a large number of fieldbuses, thus ensuring high quality and process reliability. In many cases, it is also possible to increase efficiency in the engineering process, particularly in the planning and configuring of a fieldbus system, and possibly also in the application, since the fieldbus can be selected and configured quickly and easily in a way that is almost optimal and often even optimal.

A method according to the invention is particularly suitable for integration into an engineering and/or configuration software for the design and/or configuration of a fieldbus system. It is particularly advantageous if a method according to the invention for configuring a fieldbus is carried out within such software for at least partially or completely automated configuration of a fieldbus system, in particular its fieldbus, with at least two participants.

The fieldbus system to be configured may be created as a “project” within such engineering software, for example, whereby the “project” may already contain data or information on the fieldbus system or the same may be stored when carrying out a method according to the invention, in particular as fieldbus system information. Data or information about the fieldbus system may be, or will be, available which characterize, for example, how many participants the fieldbus system has, what type of participants they are, what properties the individual participants have, how they are set up, what communication and data transmission properties the individual participants have, what type of connections the participants have, and/or how the individual participants are to be supplied with energy.

A configuration method according to the invention may, for example, be executed after being explicitly called within a corresponding engineering or configuration software or automatically after its start.

In the configuration parameter value determining step, the configuration parameters required for configuring the fieldbus can be initially selected, in particular based on fieldbus system information already stored and/or based on fieldbus system information still to be entered by a user via a user interface, for example from a large number of predefined, stored configuration parameters for a defined fieldbus type.

In some cases, it can be particularly advantageous if the configuration parameters can only be selected from a large number of predefined, stored configuration parameters that are predefined for a selected fieldbus type. This makes it possible to significantly reduce the number of configuration parameters from which one can select and for which at least one parameter value must be determined, in a simple manner. This enables a computationally and memory-efficient determination of the required configuration parameters and the associated parameter values and thus of the configuration parameter value determination step. In the further course of the process, the respective parameter values may then be determined only for the selected configuration parameters.

The associated parameter values may be determined based on at least a part of the collected fieldbus system information, in particular based on all of the collected fieldbus system information, and may be assigned to the respective configuration parameters in a preferably at least partially automated manner, preferably completely automated, for configuring the fieldbus system in the further course. That is, the respective configuration parameters required for configuring a selected field bus may be determined at least partially, preferably completely automated, the associated parameter values may be determined at least partially, preferably completely automated, and the determined parameter values may be assigned to the respective configuration parameters at least partially, preferably completely automated, so that an at least partially, preferably completely, automated configuration of the field bus is achieved. This may enable a particularly simple and efficient configuration of a selected fieldbus.

For the purposes of the present application, a fully automated execution of a method step or a sub-step can be an execution which is carried out entirely without any (human) intermediary step by a user.

Conversely, in the case of only partial automation in the process flow, one or more actions to be carried out by a user are required, for example making inputs and/or confirming an assignment of a determined parameter value to a configuration parameter or the like.

The at least partially automated determination of the one or more parameter values may take place based on at least a part of the collected fieldbus system information, preferably using a trained configuration AI model which is configured to map fieldbus system information to one or more configuration parameters for configuring the fieldbus system.

A trained AI model can be an “artificial intelligence” (AI) model trained with appropriate training data sets, i.e., a machine learning model trained with the help of suitable training data sets or a machine learning algorithm trained with the help of suitable training data sets.

The configuration AI model may comprise one or more statistical models that computer systems can use to perform a specific task without relying on explicit instructions, without requiring mathematically precisely defined, underlying models, such as an underlying regression function. For example, in machine learning, instead of a rule-based transformation or mapping of data from one value to another, a transformation or mapping of data may be used that can be derived from an analysis of historical and/or training data.

The fieldbus system information that is collected may comprise one or more selected pieces of information from a group, at least comprising: information on the existing nodes of the fieldbus system, information on the network extent of the fieldbus system, in particular on the network topology, information on the to be connected participants of the fieldbus system, information on process data communication properties of the fieldbus system, in particular information on process data communication properties of the participants of the fieldbus system, information on possible assignments of physical to logical process image (process mapping), and/or information on possible assignments of data outputs of one participant to data inputs of another participant (communication mapping).

One or more configuration parameters, the parameter value(s) of which are determined in the configuration parameter value determination step, may be used to configure a communication and/or data transmission connection and/or to configure an energy transmission connection between at least two participants of the fieldbus system, wherein the parameter values of one or more configuration parameters may be determined in such a way and the fieldbus may be configured with these in such a way that a communication and/or data and/or energy transmission connection can be, or is, established between the participants of the fieldbus system to be connected, or connected, by the fieldbus.

One or more configuration parameters, the parameter value of which can be determined in the configuration parameter value determination step, may be selected from a group comprising at least: configuration parameters for configuring node addresses of the fieldbus system, configuration parameters for configuring a required baud rate of the fieldbus, in particular configuration parameters for configuring a required baud rate based on the network extent and/or the participants and/or the data to be transmitted, configuration parameters for configuring an application requirement, configuration parameters for configuring a selection and setting of a description of one or more participants of the fieldbus system, configuration parameters for configuring a selection and setting of the process data communication properties, configuration parameters for configuring an assignment of physical to logical process image (process mapping), and/or configuration parameters for configuring an assignment of data outputs of a first participant to data inputs of a second participant of the fieldbus system (communication mapping).

Process data communication properties are properties that characterize how communication is to take place on or via the fieldbus, for example by means of cyclic polling, event-driven communication or the like.

The collecting of fieldbus system information may comprise reading fieldbus system information stored in a memory, for example in the EEPROM or in the RAM, and/or performing a scan once or several times, in particular a network scan, and/or performing a user query, in particular including reading the fieldbus system information entered by the user. Performing a user query may, for example, be performing an interactive user query in which a user is asked to enter fieldbus system information, which is then read and processed accordingly.

The configuration parameter value determination step may further comprise an automatic selection of one or more configuration parameters that are required for configuring the field bus, wherein the selection of the one or more configuration parameters may take place before the determining of the one or more associated parameter values. I.e. In other words, the configuration parameters required and/or relevant for the configuration may be selected before the associated parameter values are determined.

The determining of one or more configuration parameters may also be carried out using the trained configuration AI model or using a separate parameter selection AI model or in some other way, for example by means of a statistical classifier or using a mathematical model.

The configuration parameters may be selected based on the fieldbus to be configured and/or based on at least a part of the collected fieldbus system information, in particular with the help of a trained configuration AI model.

The above-mentioned configuration AI model may have been trained with training data which comprises a large corpus of fieldbus system information from a large number of fieldbus systems, in particular from a large number of already configured fieldbus systems, a selection of one or more configuration parameters assigned to the respective fieldbus systems, and one or more associated parameter values.

Training data may, for example, include fieldbus system information from fieldbus systems that have already been configured, as well as their associated configuration parameters and the associated parameter values, and/or fieldbus system information from fieldbus systems that have yet to be configured, in particular if at least their configuration parameters have already been selected.

The content of defined training data sets containing fieldbus system information may have been analyzed and evaluated using a machine learning model or using a machine learning algorithm and trained in this way. For the configuration AI model to be able to analyze the content of a fieldbus system information data set, the configuration AI model may have been trained using training data sets with fieldbus system information as input and training content information, such as configuration parameters and associated parameter values, as output.

By training the configuration AI model with a large number of training data sets and/or training sequences (e.g., fieldbus system information from already configured fieldbuses or fieldbus systems) in conjunction with associated training content information (e.g., expert-assessed configuration parameter values that are associated with the fieldbus system information and originate, for example, from already configured fieldbuses or fieldbus systems), the configuration AI model may have “learned” to recognize the content of the fieldbus system information, so that the content of fieldbus system information not included in the training data can be recognized using the configuration AI model.

The same principle may be used for other types of input information as well: by training a machine learning model using training data and a desired output, the machine learning model “learns” a transformation or mapping between the input data and the output, which can be used to generate an output based on non-training data provided to the machine learning model. The provided input data, for example the fieldbus system information as described above, may be preprocessed to obtain a feature vector which is used as input for the machine learning model.

The configuration AI model may have been trained using a training procedure which is referred to as “Supervised Learning”. With Supervised Learning, the machine learning model may be trained using a plurality of training samples, where each sample may comprise a plurality of input data values and a plurality of desired output values, i.e., each training sample may be associated with a desired output value. By specifying both, training samples and desired output values, the machine learning model “learns” which output value (parameter values) to output based on the input samples (fieldbus system information) that are similar to the samples provided during training.

The Supervised Learning may be based on a Supervised Learning algorithm (e.g., a classification algorithm, a regression algorithm or a similarity learning algorithm). Classification algorithms may be used if the outputs are restricted to a limited set of values (categorical variables), i.e, the input may be classified as one of a limited set of values. Regression algorithms may be used if the outputs represent numerical values (within a range). Similarity learning algorithms may be similar to both classification and regression algorithms but are based on learning from examples using a similarity function that measures how similar or related two objects are.

Besides Supervised Learning, “Semi Supervised Learning” may be used to train the configuration AI model. With Semi Supervised Learning, some of the training samples may lack a desired output value.

Besides Supervised Learning or Semi Supervised Learning, “Unsupervised Learning” may be used to train the configuration AI model. With Unsupervised Learning (only) input data may be provided and an Unsupervised Learning algorithm may be used to find structure in the input data (e.g., by grouping or clustering the input data, finding commonalities/correlations in the data). Clustering is the assignment of input data comprising a plurality of input values to subsets (clusters) such that input values within the same cluster are similar according to one or more (predefined) similarity criteria, while they are dissimilar to input values contained in other clusters.

Reinforcement learning is a third group of machine learning algorithms and may also have been used to train the configuration AI model. In reinforcement learning, one or more software actors (so-called “software agents”) are trained to perform actions in an environment. Based on the actions taken, a reward is being calculated. Reinforcement learning is based on training one or more software agents to select the actions in such a way that the cumulative reward is increased, resulting in software agents who become better at the task with which they are charged (witnessed by increasing rewards).

Furthermore, feature learning may have been used and/or the configuration AI model may include a feature learning component. Feature learning algorithms, also known as “Representation Learning algorithms” may preserve the information in their input but transform it in a way that makes it useful, often as a preprocessing stage before performing classification or prediction. Feature learning may, for example, be based on principal component analysis or cluster analysis.

Further, anomaly detection (i.e., outlier detection) may be used which may be directed at identifying grossly deviating input values that differ significantly from the bulk of the input and training data. I.e., the configuration AI model may be at least partially trained using anomaly detection and/or an anomaly detection component.

The configuration AI model may include a decision tree as a predictive model. I.e., the configuration AI model may (also) be based on a decision tree. With a decision tree, the observations about an object (e.g., a set of input values) may be represented by the branches of the decision tree, and an output value corresponding to the object may be represented by the leaves of the decision tree. Decision trees may support both discrete values and continuous values as output values. If discrete values are used, the decision tree may be called a classification tree; if continuous values are used, the decision tree may be called a regression tree.

Furthermore, the configuration AI model may be based on one or more association rules. Association rules may be created by identifying relationships between variables in large data sets. The configuration AI model may identify and/or use one or more relationship rules that represent the knowledge derived from the data. The rules may be used, for example, to store, manipulate or apply the knowledge.

For configuring a fieldbus, the configuration AI model can comprise an artificial neural network (ANN) or is such, in particular a multi-layer artificial neural network with at least one hidden layer (“deep learning” network).

ANNs are systems inspired by biological neural networks such as those found in a retina or brain. ANNs comprise a plurality of interconnected nodes and a plurality of connections, called edges, between the nodes. There are typically three types of nodes, input nodes that receive input values, hidden nodes that are (only) connected to other nodes, and output nodes that provide output values. Each node may represent an artificial neuron. Every edge may forward information from one node to another. The output of a node may be defined as a (nonlinear) function of its inputs (e.g., the sum of its inputs). The inputs of a node may be used in the function based on a “weight” of the edge or node providing the input. The weight of nodes and/or edges may be adjusted in the learning process. Training an artificial neural network may involve adjusting the weights of the nodes and/or edges of the artificial neural network, i.e., to achieve a desired output for a given input.

The configuration AI model may be, or comprise, a support vector machine, a random forest model or a gradient boosting model. Support vector machines (i.e., support vector networks) are supervised learning models with associated learning algorithms that may be used to analyze data (e.g., in a classification or regression analysis). Support vector machines may be trained by providing an input with a plurality of training input values belonging to one of two categories. Support vector machines may be trained to assign a new input value to one of the two categories. Alternatively or additionally, the configuration AI model may be, or comprise, a Bayesian network, which is a probabilistic directed acyclic graphical model. A Bayesian network may represent a set of random variables and their conditional dependencies based on a directed acyclic graph. Alternatively or additionally, the configuration AI model may be based on a genetic algorithm, which is a search algorithm and heuristic technique that mimics the process of natural selection.

For configuring a field bus, the configuration of the field bus can comprise outputting, in particular displaying on a display, at least one determined parameter value for at least one configuration parameter, and/or automatically assigning at least one determined parameter value to the respectively associated configuration parameter, and/or storing the one or more determined parameter values in a memory, for example, in the EEPROM or RAM.

During configuration, i.e., in the configuration step, all parameter values may be assigned to the configuration parameters, in particular the selected and/or required configuration parameters, preferably fully automated, and in particular in parallel. However, it is also conceivable to display only some parameter values and to assign only individual parameter values completely automated and thus set the corresponding configuration parameters. In some cases, it may be advantageous if the assignment of some parameter values will be manually confirmed, in particular must be manually confirmed, through user input. This may be particularly advantageous if a determined value lies outside a corresponding, defined confidence interval and may therefore be classified as untrustworthy.

The trustworthiness of at least one determined parameter value may also be determined in reliance upon statistical methods and/or a predefined confidence interval.

The method according to the invention for configuring a fieldbus may further comprise a selection step which comprises selecting a suitable fieldbus for connecting the at least two participants of the fieldbus system, in particular an at least partially automated selection of the fieldbus, wherein the selection of the suitable fieldbus may take place before the configuration parameter value determination step and preferably after the information collection step.

Selecting the appropriate field bus may comprise determining defined selection criteria according to which the field bus is selected, determining the associated values of the determined selection criteria, analyzing the determined values of the determined selection criteria, and selecting at least one appropriate field bus based on the result of the analysis of the criteria values.

By an at least partially automated selection of a suitable fieldbus, the susceptibility to errors in the configuration may be further reduced. By a fully automated selection of a suitable fieldbus, the susceptibility to errors may be reduced even further.

One or more defined selection criteria that are determined may be one or more criteria from a group, at least comprising: a required data transmission speed, in particular within the fieldbus system and/or on the fieldbus to be configured, a required data transmission rate, in particular within the fieldbus system and/or on the fieldbus to be configured, the number and size of the data to be transmitted, in particular within the fieldbus system and/or on the fieldbus to be configured, a required number of participants, in particular of the fieldbus system and/or on the fieldbus to be configured, a required response time, in particular within the fieldbus system and/or of the fieldbus to be configured, a required topology, in particular of the fieldbus system and/or of the fieldbus to be configured and the participants connected to it, a required transmission medium, a required transmission method, a required connection technology, a required maximum extension per participant, a required energy supply via fieldbus, a required area of application (inside, outside, dry, damp), a component requirement (such as required/additional Components, for shielding, connection, special cables, etc.), internal availability (stock), external stock (availability of goods), costs incurred, and/or an available budget.

Costs incurred may for example, be (maximum) acquisition costs and/or (maximum) operating costs that arise when selecting a specific fieldbus, or component costs that arise due to a special component requirement for a selected fieldbus type.

Determining the values of the selection criteria may involve reading at least one criteria value stored in a memory and/or performing a user query in which a user is prompted, for example, to enter a criteria value associated with one or more criteria as well as reading the criteria values entered by the user. Determining the values of the selection criteria may alternatively or additionally be carried out by querying a database for one or more criteria values included in the database.

The analysis and selection of the suitable field bus may be based on at least a part of the determined criteria values using a trained fieldbus selection AI model configured to map one or more criteria values to at least one selection parameter whose parameter value represents a fieldbus selected as suitable.

If the result is only a single selection parameter value, only a single fieldbus is suitable. If several fieldbuses or fieldbus types are identified as suitable, it may be advantageous in some cases if the fieldbus is only finally selected after manual confirmation by a user (and corresponding user input).

The analysis and selection of the appropriate fieldbus may be carried out based on at least a part of the collected fieldbus system information, in which case the fieldbus selection AI model preferably is also configured to map fieldbus system information together with one or more criteria values to at least one selection parameter whose parameter value represents a fieldbus selected as suitable.

A fieldbus selection AI model that is used may have been trained with training data that includes a variety of criteria and criteria values from a variety of fieldbus systems as input data. The training data may comprise information on a plurality of already configured fieldbus systems, as well as a selection of one or more selection parameters assigned to the respective fieldbus systems as output data, each of which represents a fieldbus selected as suitable for the associated fieldbus system.

The fieldbus selection AI model may be trained and/or designed analogously to the configuration AI model described above, in particular with the training methods described in this context, but preferably with a large number of criteria and criteria values from a large number of fieldbus systems, in particular from a large number of already configured fieldbus systems, as input data and a selection of one or more selection parameters assigned to the respective fieldbus systems as output data, each representing a fieldbus selected as suitable for the associated fieldbus system.

The fieldbus selection AI model may also comprise, or be, an artificial neural network (ANN), in particular an artificial neural network with at least one hidden layer (“deep learning” network).

The selection of the field bus may further comprise outputting at least one selection parameter value which represents at least one field bus selected as suitable, in particular displaying it on a display. It is also conceivable that several fieldbuses or fieldbus types are suitable, which may also be output.

Selecting the fieldbus may comprise determining a fieldbus to be used, in particular a single fieldbus to be used, from the fieldbuses determined to be suitable, automatically assigning the selection parameter value of the fieldbus to be used to an associated configuration parameter of the fieldbus system with which the fieldbus to be used/used is set, and optionally storing the selection parameter value of the fieldbus to be used in a memory.

The values of the criteria relevant for the selection of a suitable fieldbus may be determined, for example, completely or partially from data stored in a corresponding engineering software that has been stored in connection with a fieldbus system configuration project and/or by a scan, in particular a network scan, which is being carried out or has been carried out to determine the criteria values.

The user may also be asked to specify additional criteria for narrowing down or selecting, for example with the help of a wizard, i.e., with the help of a guided query or with the help of a query assistant.

This makes it easy to determine, for example, which connection technology is available to the individual participants of the fieldbus system and which topology must be supported by the fieldbus.

In the further course of the process, an automatic analysis of the data to be transmitted (based on the stored information) may be used to determine which data transmission rate the fieldbus must support in order to enable reliable data transmission.

If several fieldbuses or fieldbus types are generally suitable, it may be advantageous if a user-specific narrowing down is then put in effect by means of a supplementary and final wizard, i.e., by means of a user query, in particular with the help of a query assistant, which, based on the budget or area of application, further narrows down the selection of suitable fieldbuses or allows to directly select a suitable fieldbus.

Once the fieldbus is selected, in particular if a single fieldbus is determined, it may be configured by performing the configuration parameter value determination step and the configuration step.

The examples and advantages presented above with reference to the method for configuring a field bus also apply accordingly even if not explicitly mentioned or described in connection with another aspect of the invention for a fieldbus system according to the invention, a computer program according to the invention, a storage medium according to the invention, a training data set according to the invention and a method according to the invention for training a configuration AI model, provided that they are correspondingly transferable and technically executable and vice versa.

A fieldbus system according to the invention comprises a first participant and a second participant which are to be, or are, connected to one another by a fieldbus, wherein the fieldbus system has means for carrying out a method according to the invention and/or is designed to be connected to a means which is designed to carry out a method according to the invention and to be configured with the aid of this means by a method according to the invention.

An apparatus for carrying out a method according to the invention may be, for example, a control device or a computer. The apparatus, in particular a control device or a computer or the like, may be part of the fieldbus system, or it may be a non-permanent component of the fieldbus system, but may be connected, in particular communicatively connected for data transmission, to the fieldbus system for configuration purposes.

The method according to the invention may be embodied by a computer program or a plurality of computer programs which may exist in a variety of forms, both active and inactive, in a single computer system or in multiple computer systems. They may, for example, be in the form of software program(s), which includes program instructions in source code, object code, executable code, or other formats for performing some of the steps. Any of the above programs may be embodied in compressed or uncompressed form on a computer-readable medium, including storage devices and signals.

A computer program according to the invention comprises instructions which, when the program is executed by a computer, cause the computer to carry out a method according to the invention for configuring a field bus.

The term “computer” can refer to any electronic device that contains a processor, such as a general-purpose central processing unit (CPU), a dedicated processor, or a microcontroller. A computer is capable of receiving data (an input), performing a sequence of predetermined operations on it, and thereby producing a result in the form of information or signals (an output). Depending on the context, the term “computer” can mean, for example, a processor or refers more generally to a processor in conjunction with an arrangement of interconnected elements in a single housing.

A computer-readable storage medium according to the invention comprises instructions which, when executed by a computer, cause the computer to carry out a method according to the invention for configuring a field bus.

A “computer-readable medium” or “storage medium” may be any means that can contain, store, communicate, distribute, or transport the program for use by, or in connection with, the instruction execution system, apparatus, or device, as used herein. The computer-readable medium may be, for example but not limited to, an electronic, magnetic, optical, electromagnetic, infrared or semiconductor system, device, apparatus or transmission medium. More specific examples (a non-exhaustive list) of the computer-readable medium may include: an electrical connection having one or more wires, a portable computer diskette, a random-access memory (RAM), a read-only memory (ROM), an erasable programmable read-only memory (EPROM or flash memory), an optical fiber, and a portable compact disc read-only memory (CDROM).

A training data set according to the invention for training the configuration AI model comprises a plurality of fieldbus system information from a plurality of fieldbus systems, a selection of one or more configuration parameters assigned to the respective fieldbus systems, and one or more associated parameter values.

A method according to the invention for training the configuration AI model may be carried out using a training data set according to the invention.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration

FIG. 1 shows a block diagram of a first embodiment of a fieldbus system according to the invention,

FIG. 2 shows a flow chart of an embodiment of a method according to the invention for configuring a field bus,

FIG. 3 shows a flow chart with the individual sub-steps of the selection step S2 from the flow chart in FIG. 2,

FIG. 4 shows an embodiment of a fieldbus selection AI model in the form of an artificial neural network with a hidden layer, and

FIG. 5 shows an embodiment of a configuration AI model in the form of an artificial neural network with a hidden layer.

### DETAILED DESCRIPTION

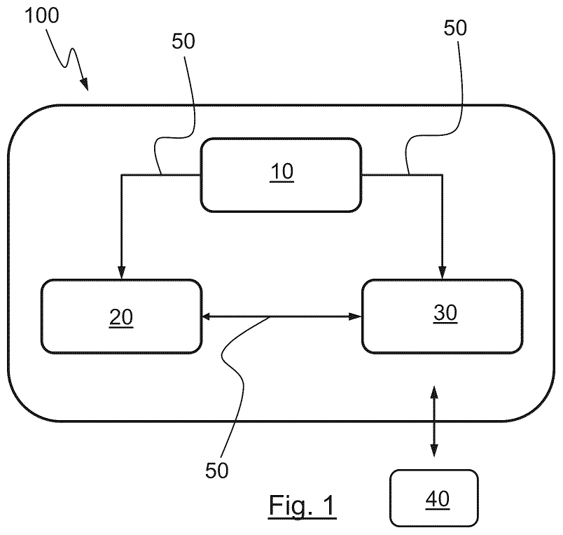

FIG. 1 shows an embodiment of a fieldbus system 100 according to the invention with three participants: a control device 10, a first participant 20, which in this example is a sensor, and a third participant 30, which is an actuator. The three participants 10, 20 and 30 are connected to one another via a field bus 50, in particular by means of a corresponding field bus cable not specified here and can exchange data with one another via the field bus 50. FIG. 1 merely serves to schematically show possible embodiments of a fieldbus system 100 according to the invention but shall in no way be understood as limiting in this regard. A fieldbus system according to the invention may therefore have a different number and arrangement of the participants 10, 20, 30, a different topology and extent and a different type of participants 10, 20 and 30.

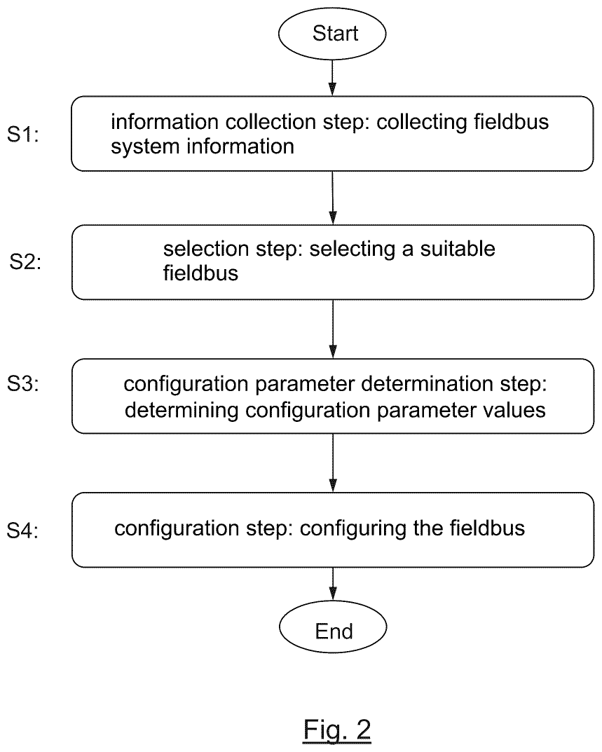

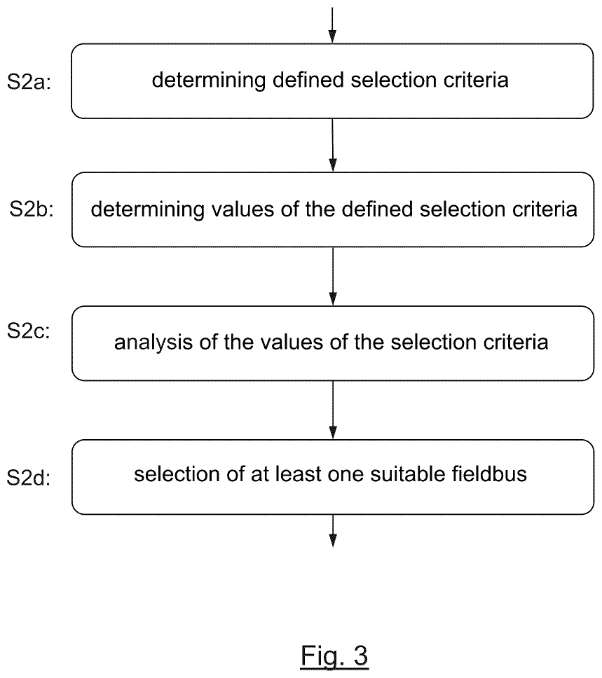

The control device 10 is not only set up for the operational control of the field bus system 100, i.e., for controlling the field bus system 100 during its operation, but also for configuring the field bus 50, wherein the control device 10 is set up to configure the field bus 50 by means of a method according to the invention (cf. FIGS. 2 and 3). I.e., in this exemplary embodiment, the control device 10 represents the means for carrying out a method according to the invention of the field bus system 100 according to the invention and is set up to carry out a method according to the invention and to determine configuration parameter values KFPW (cf. FIG. 5) and to configure the field bus 50.

This embodiment of a fieldbus system 100 according to the invention is further designed to be configured by means of an external, further control device 40, which can be connected to the fieldbus system 100 for communication.

In another possible embodiment of a fieldbus system according to the invention, the fieldbus system can also be designed only to be connected to an external means, for example an external control device 40, which is set up to carry out a method according to the invention for configuring the fieldbus, or to an external computer 40 on which, for example, engineering software runs, in which a computer program for carrying out a method according to the invention is integrated, and to be configured by means of this external means 40.

The configuration of the fieldbus 50 of the fieldbus system 100 by means of an external control device 40 has the advantage over an internal control device 10 for configuring the fieldbus 50 that the external control device 40 can be flexibly replaced or adapted in a simple manner. Furthermore, with a large number of fieldbus systems 100 to be configured, in particular with a large number of similar or identical fieldbus systems 100 to be configured, it may be more cost-effective to use only one external control device 40 or only one external means 40 and thereby configure all fieldbus systems 100 one after the other than to provide a separate, integrated control device 10 for each fieldbus system 100, which is set up for configuration of the fieldbus 50 by means of a method according to the invention. However, this depends on the specific individual case and may vary from application to application.

The control devices 10 and 40, i.e., both the internal control device 10 and the external control device 40 shown in FIG. 1 in this embodiment, are each designed to carry out a method according to the invention for configuring the field bus 50, which is explained in more detail below with reference to FIGS. 2 to 5.

FIG. 2 shows a flow chart of an embodiment for explaining the basic process sequence of a method according to the invention for configuring a fieldbus 50 of a fieldbus system, for example for configuring the fieldbus 50 of the fieldbus system 100 according to the invention from FIG. 1.

FIG. 3 shows a flow chart with the individual substeps of the selection step S2 from the flow chart in FIG. 2.

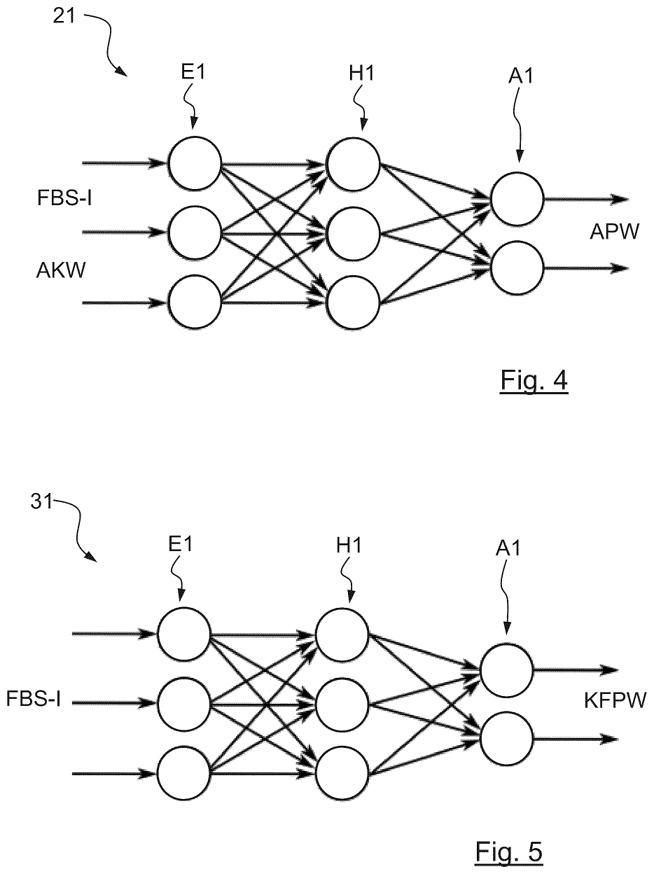

FIG. 4 shows an embodiment of a fieldbus selection AI model in the form of an artificial neural network with a hidden layer, by means of which a suitable fieldbus or fieldbus type can be selected, for example, in the selection step S2.

FIG. 5 shows an embodiment of a configuration AI model in the form of an artificial neural network with a hidden layer, by means of which, for example, in the configuration parameter value determination step S3, the associated parameter values KFPW can be determined for the configuration parameters required for a configuration of a selected, suitable field bus.

The control devices 10 and 40 of the fieldbus system 100 are designed, in particular, to initially collect fieldbus system information FBS-I in a first step S1, an information collection step, wherein in this embodiment the collection of fieldbus system information FBS-I is carried out, in particular, completely automated, for example by reading fieldbus system information FBS-I stored in the EEPROM of the control device 10 or the external means 40. Furthermore, alternatively or additionally, a scan, in particular a network scan, may be carried out once or several times.

However, the collection of fieldbus system information FBS-I can also be only partially automated. If, for example, not all of the fieldbus system information FBS-I required for configuring the fieldbus 50 is available after the two aforementioned steps, in particular those carried out fully automated, a user query, in particular an interactive user query, may also be carried out if required, in which a user is prompted, for example, to enter the fieldbus system information that is still missing, which may then be read and processed further accordingly. Alternatively, it is also conceivable to only perform a user query.

The fieldbus system information FBS-I collected in step S1 is, in particular, information that characterizes the fieldbus system 100. In this case, for example, information on the existing nodes of the fieldbus system, information on the network extent of the fieldbus system, in particular on the network topology, information on the participants of the fieldbus system to be connected, information on process data communication properties of the fieldbus system, in particular information on process data communication properties of the participants of the fieldbus system, information on possible assignments of physical to logical process images (process mapping), as well as information on possible assignments of data outputs of one participant to data inputs of another participant (communication mapping) are collected.

In a next step S2, a selection step, a suitable fieldbus, in particular a suitable fieldbus type, in particular from a group comprising the following fieldbus types CANopen, CC-Link, ControlNet, DeviceNet, Interbus, Profibus, Ethernet/IP, Modbus TCP and/or Profinet, is selected.

The selecting of a suitable field bus in selection step S2 is preferably also carried out completely automated in this embodiment and may, as shown for example in FIG. 3, comprise the following sub-steps: determining defined selection criteria (step S2a), determining associated selection criteria values AKW (step S2b), performing an analysis of the determined values of the previously determined selection criteria values AKW (step S2c) and selecting at least one suitable fieldbus or fieldbus type based on the result of the analysis (step S2d).

The selecting of a suitable fieldbus in step S2 is carried out in this embodiment of a method according to the invention in particular with the help of a trained fieldbus selection AI model in the form of an artificial neural network 21 as shown in FIG. 4 by way of example, based on certain selection criteria and the associated, determined values of these selection criteria, i.e., based on determined selection criteria values AKW, and in this example also based on the fieldbus system information FBS-I previously collected in the information collection step S1, see FIG. 4.

Selection criteria that may be determined are, for example, a required data transmission speed within the fieldbus system 50, in particular on the fieldbus 50 to be configured, a required data transmission rate, number and size of the data to be transmitted, the number of participants in the fieldbus system 100, a required response time, a required transmission method, a required connection technology, in particular due to the participants 10, 20 and 30 of the fieldbus system 100, a required area of application (indoor, outdoor, dry, damp), a component requirement (such as required/additional components for shielding, for connection, special cables, etc.), internal availability (stock), external stock (availability of goods), as well as costs resulting from a selection of a certain fieldbus type and/or an available budget.

The values of the selection criteria AKW are determined, in particular, by reading the values of the specific defined selection criteria from a memory, for example the EEPROM or the RAM of the control device 10 or 40. Alternatively or additionally, the AKW values of the selection criteria may also be determined by a database query or a user query.

The analysis of the values AKW of the selection criteria in sub-step S2c and the final selection of a suitable fieldbus in sub-step S2d may be carried out with the aid of a trained fieldbus selection AI model 21, which in this embodiment may, for example, be a trained artificial neural network (ANN) 21 with an input layer E1, a hidden intermediate layer H1, and an output layer A1, as shown by way of example in FIG. 4.

The fieldbus selection AI model 21 may have been trained beforehand using appropriate training data sets, in particular according to the method of “Supervised Learning”, and configured to map one or more selection criteria values to a selection parameter whose parameter value APW represents a suitably designed fieldbus. The trained fieldbus selection AI model may be specifically configured to map input data in the form of selection criteria values AKW and collected fieldbus system information FBS-I to a selection parameter and, in particular, to assign to this a selection parameter value APW, which represents the specific selection of one or more selected fieldbuses and in particular indicates which fieldbus has been selected as suitable. Selecting a suitable fieldbus or fieldbus type may include assigning the result to a selection parameter and outputting an associated selection parameter value APW.

Instead of selecting the fieldbus in a selection step S2, in an alternative embodiment of a method according to the invention, it may also be specified or already have been specified, for example, by a user input or the like. It is also conceivable to carry out the selection step before the information collection step S1. However, it may be more advantageous to carry out the selection step S2 after the information collection step S1, since this way the information collected in step S1 may also be taken into account in the selection of the fieldbus in step S2.

If a suitable fieldbus is selected, the parameter values KFPW (see FIG. 4) of the configuration parameters required to configure the fieldbus 50 may then be determined in a further step S3, a configuration parameter value determination step.

The determination of the parameter values KFPW in the configuration parameter determination step S3 may be carried out based on the properties of the fieldbus system 100, in particular based on the fieldbus system information FBS-I determined in step S1 and the fieldbus type selected in step S2 or a predetermined fieldbus type.

To determine the parameter values KFPW of the configuration parameters, in this example the configuration parameters required to configure the selected fieldbus 50 are first selected, whereby in the embodiment shown these are selected based on the collected fieldbus system information FPS-I. The configuration parameters may be selected from a variety of predefined configuration parameters stored for the selected fieldbus type. Once the individual configuration parameters required to configure the selected fieldbus type or fieldbus have been selected, the corresponding parameter values may be determined.

In this embodiment, configuration parameters for configuring node addresses of the fieldbus system, configuration parameters for configuring a required baud rate of the fieldbus, in particular configuration parameters for configuring a required baud rate based on the network extent and/or the participants and/or the data to be transmitted, configuration parameters for configuring an application requirement, configuration parameters for configuring a selection and setting of a description of one or more participants of the fieldbus system, configuration parameters for configuring a selection and setting of the process data communication properties, configuration parameters for configuring an assignment of physical to logical process image (process mapping), as well as configuration parameters for configuring an assignment of data outputs of a first participant to data inputs of a second participant of the fieldbus system (communication mapping) are selected and the respective associated parameter values are determined for these.

In this embodiment, the configuration parameter values are determined in the configuration parameter value determination step S3 using a trained configuration AI model in the form of an artificial neural network (ANN) 31, which, for example, as shown exemplarily in FIG. 5, may have a single input layer E1, a single hidden layer H1 and a single output layer A1, and which may be configured to map input data in the form of the fieldbus system information FBS-I to the configuration parameter values KFPW sought. However, other designs of a configuration AI model are also conceivable.

The configuration AI model 31 may have been trained by means of appropriate training methods with a large number of suitable training data sets, in particular training data sets according to the invention, as described at the beginning, wherein in this embodiment the training may be carried out according to the method of “Supervised Learning”.

After determining the configuration parameter values KFPW in step S3, in order to configure the fieldbus system 100 in this example, the determined parameter values KFPW of the configuration parameters for configuring the fieldbus 50 may be output and shown on a display, assigned to the respective required configuration parameters and stored in a memory, for example in an EEPROM of the control device 10 or in the RAM of the control device 10, by means of which the fieldbus system 100 is controlled. The determined configuration parameter values KFPW may be stored in an internal memory of the fieldbus system 100, in particular in an internal memory of a control device 10 which is set up to control the fieldbus system 100, in particular to control the fieldbus 50.

Furthermore, the trustworthiness may be determined for the determined parameter values KFPW, which can often further improve the reliability of the fieldbus configuration. If the determined trustworthiness is not sufficient, a message may be issued to a user, for example, that the parameter values must be checked manually in order to avoid damage to the components of the fieldbus system due to incorrect configuration. This allows for a particularly safe and reliable configuration of a fieldbus system to be achieved.

All process steps may be carried out fully automated in order to minimize the configuration effort for a user as much as possible. Only if information is missing or fully automated processing of the information is not possible, actions by a user, such as entering additional information, may be required in some cases.

By means of a method according to the invention, a reliable, error-resistant and thus safe and reproducible as well as particularly simple and efficient configuration of a fieldbus, in particular a fieldbus system 100, may be achieved.

Further embodiments in accordance with the invention may be, or relate to, a computer program with a program code for carrying out a described method according to the invention when the computer program is executed on a computer or processor. Steps, operations or processes of a method described above may be performed by programmed computers or processors. Further embodiments may be program storage devices, e.g. digital data storage media, which are machine-readable, processor-readable or computer-readable and encode machine-executable, processor-executable, or computer-executable programs of instructions. The instructions may perform or cause some or all of the steps of the method according to the invention to be performed. The program storage devices, in particular computer-readable storage media according to the invention, may comprise, or be, for example, digital memories, magnetic storage media such as magnetic disks and magnetic tapes, hard disk drives or optically readable digital data storage media. Further embodiments may also include computers, processors or control units programmed to carry out the steps of the methods described above, or (field) programmable logic arrays ((F) PLAs) or (field) programmable gate arrays ((F) PGA) programmed to carry out the steps of the method according to the invention.

Functions of various elements shown in the figures as well as the designated functional blocks may be implemented in the form of dedicated hardware, e.g. “a signal provider”, “a signal processing unit”, “a processor”, “a controller” etc. as well as hardware capable of executing software in conjunction with associated software. When provided by a processor, the functions may be provided by a single dedicated processor, by a single shared processor, or by a plurality of individual processors, some or all of which may be shared. However, the term “processor” or “controller” is by no means limited to hardware capable of executing software only, but may also include digital signal processor (DSP) hardware, network processor, application-specific integrated circuit (ASIC), field programmable logic arrangement (FPGA), Read-only memory (ROM) for storing software, random access memory (RAM) and non-volatile storage devices. Other hardware, conventional and/or custom, may also be included.

The block diagram of FIG. 1 may also represent a rough circuit diagram, which implements the principles of the above disclosure. Similarly, the flowcharts shown may represent various processes, operations, or steps, for example, substantially embodied in a computer-readable medium and as such performed by a computer or processor, regardless of whether such a computer or processor is explicitly shown. Methods disclosed in the description or in the patent claims may be implemented by a device which comprises components for carrying out each of the respective steps of these methods.

It is to be understood that the disclosure of multiple steps, processes, operations, or functions disclosed in the specification or claims should not be construed as limiting the order of occurrence unless explicitly or implicitly indicated otherwise, e.g. for technical reasons. In particular, the present disclosure of multiple steps or functions does not limit the sequence to a particular order, unless these steps or functions are re not interchangeable for technical reasons. Furthermore, in some examples, a single step, function, process, or operation may include and/or be broken down into multiple sub-steps, functions, processes, or operations. Such sub-steps may be included and form part of the disclosure of that individual step unless they are explicitly excluded.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A computer-implemented method for an at least partially automated configuration of a field bus, which is to connect or connects at least two participants of an associated field bus system, the method comprising:
collecting, in an information collection step, fieldbus system information characterizing the associated fieldbus system;
determining, in a configuration parameter value determination step, one or more parameter values of one or more configuration parameters for configuring the fieldbus of the fieldbus system;
performing the determination of the one or more parameter values based on at least a part of the collected fieldbus system information; and
configuring, in a configuration step, the fieldbus with the one or more parameter values of the one or more configuration parameters determined in the configuration parameter value determination step.

2. The method according to claim 1, wherein the at least partially automated determining of the one or more parameter values is carried out based on at least a part of the collected fieldbus system information using a trained configuration AI model which is configured to map fieldbus system information to one or more configuration parameters for configuring the fieldbus of the fieldbus system.

3. The method according to claim 1, wherein the collected fieldbus system information is one or more selected pieces of information comprising at least:
information on the existing nodes of the fieldbus system;
information on the network extent of the fieldbus system;
information on the to be connected participants of the fieldbus system;
information on process data communication properties of the fieldbus system;
information on possible assignments of physical to logical process image; and/or
information on possible assignments of data outputs of one participant to data inputs of another participant.

4. The method according to claim 1, wherein one or more configuration parameters whose parameter value is determined in the configuration parameter value determination step from a group comprising at least:
configuration parameters for configuring node addresses of the fieldbus system;
configuration parameters for configuring a required baud rate of the fieldbus;
configuration parameters for configuring an application requirement;
configuration parameters for configuring a selection and setting of a description of one or more participants of the fieldbus system;
configuration parameters for configuring a selection and setting of the process data communication properties;
configuration parameters for configuring an assignment of physical to logical process image (process mapping); and/or
configuration parameters for configuring an assignment of data outputs of a first participant to data inputs of a second participant of the fieldbus system (communication mapping).

5. The method according to claim 1, wherein the collecting of fieldbus system information comprises:
reading fieldbus system information stored in a memory;
performing a scan once or several times; and/or
performing a user query in which a user is prompted to enter fieldbus system information and reading the fieldbus system information entered by the user.

6. The method according to claim 1, wherein the configuration parameter value determination step further comprises an automatic selection of one or more configuration parameters that are required for configuring the field bus, wherein the selection of the one or more configuration parameters takes place in particular before the determining of the one or more associated parameter values.

7. The method according to claim 2, wherein the configuration AI model has been trained with training data which comprises fieldbus system information of a plurality of fieldbus systems, a selection of one or more configuration parameters associated with the respective fieldbus systems, and one or more associated parameter values.

8. The method according to claim 2, wherein the configuration AI model comprises or is an artificial neural network.

9. The method according to claim 1, wherein configuring the field bus comprises:
outputting at least one determined parameter value for at least one configuration parameter;
automated assigning at least one determined parameter value to the respective associated configuration parameter; and/or
storing the one or more determined parameter values in a memory.

10. The method according to claim 1, wherein the method further comprises a selection step comprising selecting a suitable field bus for connecting the at least two participants of the field bus system, the selecting of the suitable field bus comprising:
determining defined selection criteria according to which the fieldbus is selected;
determining the corresponding values of the defined selection criteria;
analyzing the determined values of the selection criteria; and
selecting a selection of the suitable fieldbus based on the result of the analysis of the criteria values.

11. A fieldbus system comprising:
A fieldbus;
a first participant; and
a second participant connected to the first participant by the fieldbus,
wherein the fieldbus system is adapted to carry the method of claim 1.

12. A computer program comprising instructions which, when the program is executed by a computer, cause the computer to carry out the method according to claim 1.

13. A computer-readable storage medium comprising instructions which, when executed by a computer, cause the computer to carry out the method of claim 1.

14. A training data set for training a configuration AI model according to claim 7, the training data set comprising:
fieldbus system information of a plurality of fieldbus systems; and
a selection of one or more configuration parameters associated with the respective fieldbus systems and one or more associated parameter values.

15. A method of training a configuration AI model with the training data set according to claim 14.
